(19) United States
(12) Patent Application Publication
(10) Pub. No.: US 2013/0287244 A1
(43) Pub. Date: Oct. 31, 2013

(54) LOUDSPEAKER WITH REINFORCED FRAME

(71) Applicant: HWANG-MIAW CHEN, Tu-Cheng (TW)

(72) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/551,627

(22) Filed: Jul. 18, 2012

(30) Foreign Application Priority Data
Apr. 27, 2012 (CN) 201210127733.2

(51) Int. Cl. H04R 1/00

(52) U.S. Cl. 381/398

(57) ABSTRACT

An exemplary loudspeaker includes a frame, a yoke engaged with the frame, a magnet fixed to the yoke, a magnet fixed to the yoke, a diaphragm attached to the frame, and a voice coil attached to the diaphragm. The frame includes an annular flange and a supporting bracket. The supporting bracket includes two mounting portions respectively extending down from opposite sides of the annular flange and an annular connecting portion located between the two mounting portions. The yoke is embedded in the annular connecting portion.

### BACKGROUND

1. Technical Field

The disclosure generally relates to electroacoustic transducers, and more particularly to a loudspeaker with a strong frame that can improve the sound quality of the loudspeaker.

2. Description of Related Art

With the continuing development of audio and sound technology, loudspeakers have been widely used in electronic devices such as mobile phones, computers, televisions and other devices providing audio capabilities.

A typical loudspeaker includes a frame, a diaphragm connected with the frame, a voice coil joined to the diaphragm, and a magnet provided inside the frame. The magnet compels the voice coil to oscillate, and the oscillating voice coil drives the diaphragm to push ambient air and thereby generate sound. However, the frame of the loudspeaker is thin and easily damaged during assembly of the loudspeaker. Furthermore, the frame is liable to oscillate with the voice coil and generate a noise, thereby reducing the sound quality of the loudspeaker.

What is needed, therefore, is a loudspeaker which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, isometric view of a loudspeaker in accordance with one embodiment of the disclosure.

FIG. 2 shows the loudspeaker of FIG. 1 inverted.

FIG. 3 is a cross sectional view of the loudspeaker of FIG. 1, taken along line thereof.

FIG. 4 is an exploded, isometric view of the loudspeaker of FIG. 1.

FIG. 5 shows the loudspeaker of FIG. 4 inverted.

### DETAILED DESCRIPTION

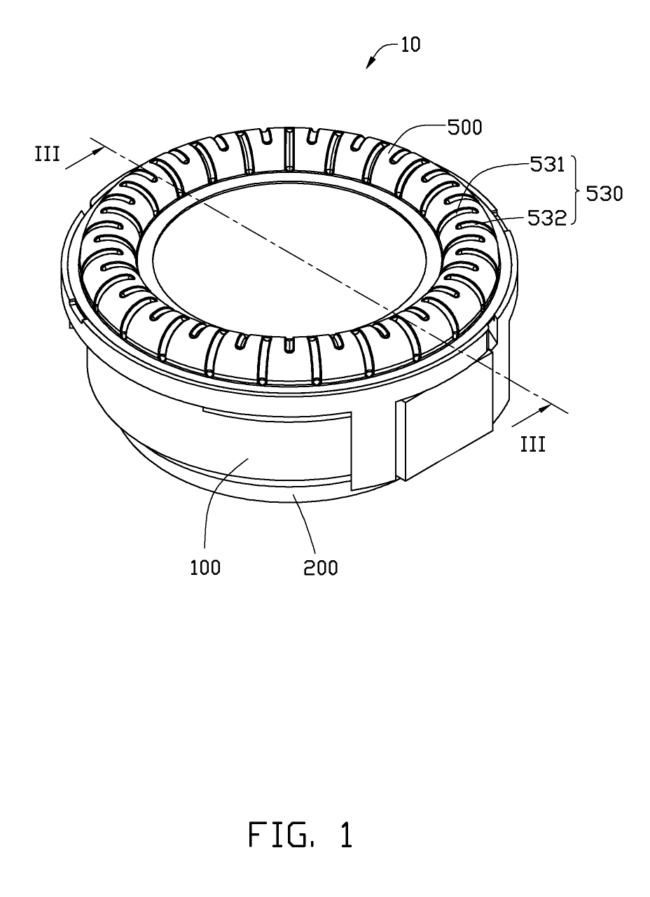

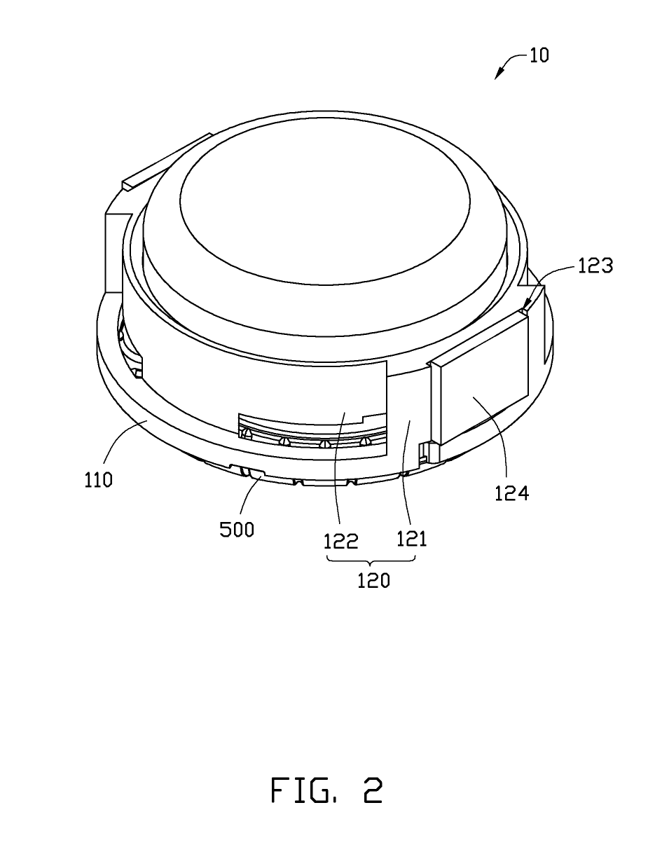

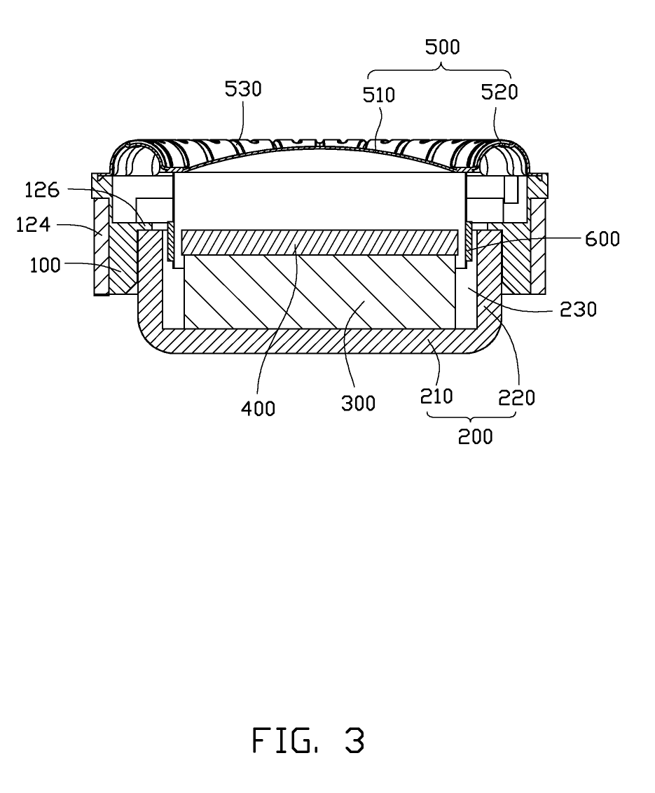

Referring to FIGS. 1-3, a loudspeaker 10 in accordance with one embodiment of the disclosure is shown. The loudspeaker 10 includes a frame 100, a yoke 200 engaged with the frame 100, a magnet 300 fixed to the yoke 200, a washer 400 located on the magnet 300, a diaphragm 500 attached to the frame 100, and a voice coil 600 attached to the diaphragm 500.

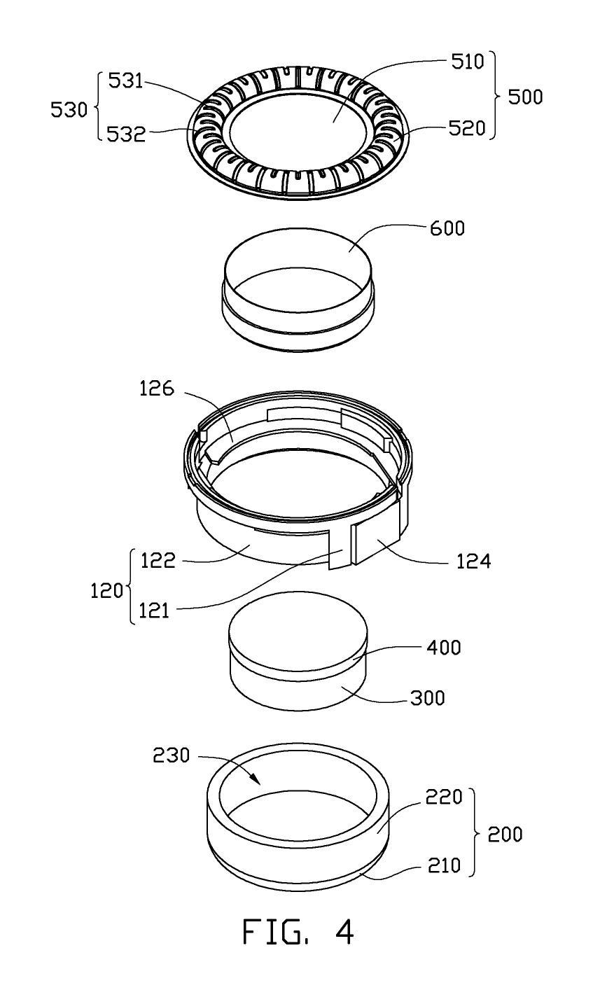

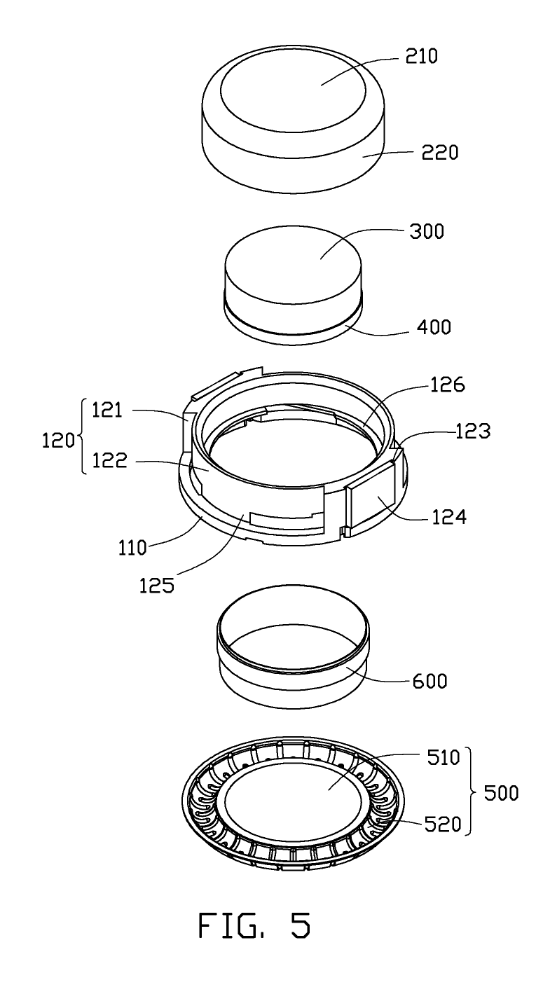

Referring also to FIGS. 4-5, the frame 100 includes an annular flange 110 and a supporting bracket 120 extending down from the annular flange 110 for reinforcing the frame 100. The supporting bracket 120 includes two mounting portions 121 respectively extending down from two opposite sides of the annular flange 110, and an annular connecting portion 122 located between the two mounting portions 121. An outer periphery of the annular connecting portion 122 is connected with inner surfaces of the mounting portions 121. Each of the mounting portions 121 defines a recess 123 in an outer surface thereof. A circuit board 124 is received in the recess 123. The annular connecting portion 122 further includes two arc-shaped connecting legs 125 connecting with the annular flange 110. The connecting legs 125 are configured to enhance an intensity (strength) of the annular connecting portion 122, thereby preventing the annular connecting portion 122 from rupturing or distorting. An inner surface of the annular connecting portion 122 further includes an annular blocking wall 126 adjacent to the annular flange 110. In this embodiment, the annular flange 110 and the supporting bracket 120 are integrally formed as a single monolithic piece of material.

The yoke 200 includes a circular bottom plate 210, and a side plate 220 extending upwardly from the bottom plate 210. The bottom plate 210 and the side plate 220 cooperatively define a receiving space 230 therebetween. An outer diameter of the yoke 200 is substantially equal to an inner diameter of the annular connecting portion 122. The yoke 200 is engaged in the annular connecting portion 122, with a top surface of the side plate 220 of the yoke 200 abutting against the annular blocking wall 126 of the annular connecting portion 122.

The magnet 300 is received in the receiving space 230 of the yoke 200 and secured to the bottom plate 210 of the yoke 200. The washer 400 is fixed on the magnet 300 to shield a magnetic field generated by the magnet 300 within the yoke 200. Therefore, the magnetic field generated by the magnet 300 is limited between the washer 400 and the bottom plate 210 of the yoke 200, to strengthen an intensity of the magnetic field.

The diaphragm 500 is attached to an upper surface of the annular flange 110. The diaphragm 500 includes a central area 510 in a center thereof, and an annular joint area 520 surrounding but spaced from the central area 510. The central area 510 is dome-shaped. The joint area 520 is curved upwardly to have a shape resembling the shape of half a doughnut (or half a torus). The joint area 520 has an arch-shaped (or arc-shaped) transverse cross-section. A plurality of grooves 530 are defined in the joint area 520. The grooves 530 include a first group of grooves 531 extending from an inner circular side of the joint area 520 adjacent to the central area 510 to a top portion of the joint area 520, and a second group of grooves 532 extending from an outer circumferential side of the joint area 520 to the top portion of the joint area 520. The first group of grooves 531 and the second group of grooves 532 are spaced from one another, and are arranged alternately to increase a rigidity of the diaphragm 500.

The voice coil 600 is an annular electrically conductive coil. One terminal of the voice coil 600 is secured to a joint portion of the diaphragm 500 located between the central area 510 and the joint area 520. Another terminal of the voice coil 600 is inserted into a gap between the side plate 220 of the yoke 200 and the magnet 300.

In operation of the loudspeaker 10, when a driving current is applied to the voice coil 600, the voice coil 600 generates a magnetic field. The magnetic field generated by the voice coil 600 and the magnetic field generated by the magnet 300 interact and compel the voice coil 600 to oscillate. The oscillating of the voice coil 600 drives the diaphragm 500 to push ambient air and thereby generate sound. Because the frame 100 includes the annular flange 110 and the supporting bracket 120, and the supporting bracket 120 includes the two mounting portions 121 mounted on the two opposite sides of the annular flange 110, the mounting portions 121 can increase the intensity of the annular flange 110 and help ensure that the frame 100 does not easily oscillate with the diaphragm 500. Therefore, noise generate by oscillating of the frame 100 is reduced or even eliminated, and the sound quality of the loudspeaker 10 is improved. In addition, with the supporting bracket 120, the frame 100 is not easily damaged in assembly of the loudspeaker 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A loudspeaker, comprising:
a frame, which comprises an annular flange and a supporting bracket, the supporting bracket comprising two mounting portions respectively extending down from opposite sides of the annular flange and an annular connecting portion located between the two mounting portions;
a yoke engaged with the frame and embedded in the annular connecting portion;
a magnet fixed to the yoke;
a diaphragm attached to the frame; and
a voice coil attached to the diaphragm.

2. The loudspeaker of claim 1, wherein an outer periphery of the annular connecting portion is connected with inner surfaces of the mounting portions.

3. The loudspeaker of claim 2, wherein each of the mounting portions defines a recess in an outer surface thereof, and a circuit board is received in the recess.

4. The loudspeaker of claim 1, wherein the annular connecting portion further comprises two arc-shaped connecting legs connecting with the annular flange.

5. The loudspeaker of claim 1, wherein the annular flange and the supporting bracket are integrally formed as a single monolithic piece of material.

6. The loudspeaker of claim 1, wherein the yoke comprises a bottom plate and a side plate extending upwardly from the bottom plate, and the magnet is secured to the bottom plate of the yoke.

7. The loudspeaker of claim 6, wherein an inner surface of the annular connecting portion further comprises an annular blocking wall, and a top surface of the side plate of the yoke abuts against the annular blocking wall.

8. The loudspeaker of claim 6, wherein the diaphragm comprises a central area in a center thereof, an annular joint area surrounding the central area, and a joint portion between the central area and the joint area, one terminal of the voice coil is secured to the joint portion, and another terminal of the voice coil is inserted into a gap between the side plate of the yoke and the magnet.

9. The loudspeaker of claim 6, further comprising a washer fixed to the magnet, the washer being configured to shield a magnetic field generated by the magnet within the yoke, whereby the magnetic field generated by the magnet is limited between the washer and the bottom plate of the yoke to strengthen an intensity of the magnetic field.

10. The loudspeaker of claim 1, wherein the diaphragm is attached to an upper surface of the annular flange.

11. The loudspeaker of claim 10, wherein the diaphragm comprises a central area in a center thereof, and an annular joint area surrounding but spaced from the central area.

12. The loudspeaker of claim 11, wherein the joint area is curved upwardly to have a shape resembling the shape of half a torus, and has an arch-shaped transverse cross-section.

13. The loudspeaker of claim 12, wherein a plurality of grooves are defined in the joint area.

14. The loudspeaker of claim 13, wherein the grooves comprise a first group of grooves and a second group of grooves, the first group of grooves extending from an inner circular side of the joint area adjacent to the central area to a top portion of the joint area, and the second group of grooves extending from an outer circumferential side of the joint area to the top portion of the joint area.

15. A loudspeaker, comprising:
a frame, which comprises an annular flange and a supporting bracket extending down from the annular flange for reinforcing the frame;
a yoke engaged with the frame and at least partly received in the supporting bracket;
a magnet fixed to the yoke;
a diaphragm attached to the frame; and
a voice coil attached to the diaphragm.

16. The loudspeaker of claim 15, wherein the annular flange and the supporting bracket are integrally formed as a single monolithic piece of material.

17. The loudspeaker of claim 15, wherein the yoke comprises a bottom plate and a side plate extending upwardly from the bottom plate, and the magnet is secured to the bottom plate of the yoke.

18. The loudspeaker of claim 15, wherein the diaphragm is attached to an upper surface of the annular flange.

19. The loudspeaker of claim 18, wherein the diaphragm comprises a central area in a center thereof and an annular joint area surrounding but spaced from the central area.

20. The loudspeaker of claim 19, wherein the joint area is curved upwardly to have a shape resembling the shape of half a torus, and has an arch-shaped transverse cross-section.
